(19) United States
(12) Patent Application Publication
(10) Pub. No.: US 2025/0242430 A1
(43) Pub. Date: Jul. 31, 2025

(54) WELDING METHOD OF MEMBERS

(71) Applicant: KABUSHIKI KAISHA TOSHIBA, Tokyo (JP)

(72) Inventor: Taizo TOMIOKA, Yokohama (JP)

(73) Assignee: KABUSHIKI KAISHA TOSHIBA, Tokyo (JP)

(21) Appl. No.: 18/830,956

(22) Filed: Sep. 11, 2024

(30) Foreign Application Priority Data
Jan. 30, 2024 (JP) 2024-012042
Jun. 6, 2024 (JP) 2024-091988

(51) Int. Cl. B23K 20/12

(52) U.S. Cl. CPC B23K 20/125; B23K 20/1225

(57) ABSTRACT

A welding method of metal members includes a process of forming a fine crystal grain layer at a surface being weld of one metal member or both of metal members by friction stir processing using rotating a friction stir processing tool; a process of overlapping the metal members to face the surface being welded each other; and a process of pressing and heating from area the surface opposite to the surfaces being welded of metal members.

### CROSS-REFERENCE TO RELATED APPLICATIONS

This application is based upon and claims the benefit of priority from Japanese Patent Application No. 2024-012042, filed on Jan. 30, 2024; Japanese Patent Application No. 2024-91988, filed on Jun. 6, 2024; the entire contents of which are incorporated herein by reference.

### FIELD

Embodiments described herein relate generally to a welding method of members.

### BACKGROUND

For example, friction stir spot welding (FSSW) has been proposed as a lap welding method for members including metals. Compared to, for example, resistance welding (spot welding), friction stir spot welding has the advantage of requiring less electric power to weld low electrical resistance metals such as aluminum, etc.

Here, a welding tool used in FSSW generally includes a shoulder, and a stirring pin protruding from the shoulder. When performing friction stir spot welding, a rotating welding tool is pressed onto overlapped metal plates so that the shoulder is inserted into the upper metal plate, and the stirring pin is positioned inside the upper and lower metal plates. Therefore, the shape of the welding tool is transferred to the welded portion when performing friction stir spot welding. In other words, a shallow indentation, which is the mark caused by the penetration of the shoulder, and a deep indentation, which is the mark caused by the penetration of the stirring pin, are formed in the welded portion.

FSSW technology has been proposed in which a fine crystal grain sheet is interposed between the metal plates, or a fine crystal grain layer is formed between the metal plates. However, such technology also uses a welding tool including a shoulder and a stirring pin protruding from the shoulder, and so the deep indentation, i.e., the mark caused by the penetration of the stirring pin, is formed in the welded portion.

A deep indentation in the welded portion detracts from the aesthetics of the product. A deep indentation in the welded portion also is problematic in that moisture and the like easily collects in the indentation and requires long time for evaporation, thereby degrading the reliability of the welded portion and/or product. In such a case, the occurrence of the deep indentation at the central portion of the weld can be avoided simply by eliminating the stirring pin; however, it becomes difficult for the stir zone to reach the contact interface between the metal plates, and it is difficult to obtain the necessary weld strength. To obtain the necessary weld strength with a welding tool without a stirring pin, it is necessary for the shoulder to be deeply inserted into the top plate, and ultimately, a deep indentation remains in the welded portion.

Also, technology has been proposed in which the stirring pin and the shoulder are separate bodies driven individually, and softened metal is used to fill the deep indentation described above. However, it is problematic to individually drive the stirring pin and the shoulder because the structure of the welding tool is complex, and the cost of the welding tool is higher. Also, because the shoulder is inserted to a depth that is not less than the thickness of the upper metal plate, the welding load is higher, and a highly rigid friction stir welding apparatus is necessary. Such a friction stir welding apparatus also is more expensive. Furthermore, because the stirring pin and the shoulder slide as separate bodies, softened metal may enter the gap between the stirring pin and the shoulder, making the side surfaces of the stirring pin and the shoulder prone to wear. Therefore, there are cases where the strength of the welding tool decreases over time (see Non-Patent Literature 1).

It is therefore desirable to develop a welding method for members that can suppress the occurrence of a deep indentation in the welding portion even when a welding tool having a simple configuration is used.

### BRIEF DESCRIPTION OF THE DRAWINGS

FIG. 1 is a schematic view illustrating an apparatus for friction stir processing (FSP) and welding;

FIGS. 2A to 2D are schematic process drawings illustrating a welding method of members according to an embodiment;

FIGS. 3A to 3C are schematic process drawings illustrating a welding method of members according to another embodiment;

FIGS. 4A to 4D are schematic process drawings illustrating a welding method of members according to another embodiment;

FIG. 5 is a photograph of the surface of the member after friction stir processing;

FIG. 6 is a photograph of the members after welding by frictional heat and pressing using a rotating welding tool; and

FIG. 7 is a photograph of a cross section of a welded portion of the members.

FIG. 8 is a friction stir processing tool having projections of blade like shapes.

### DETAILED DESCRIPTION

A welding method of members according to an embodiment includes a process of forming a first layer in a first member on a first backing plate by rotating a friction stir processing (FSP) tool to perform FSP, the first layer including a fine crystal grain structure, the first layer being formed in a surface of the first member at a side opposite to the first backing plate side; a process of placing a second member on a surface of the first member at the first layer side; and a process of pressing and heating an area of a surface of the second member at a side opposite to the first member side, the area overlapping the first layer.

Exemplary embodiments will now be described with reference to the drawings. Similar components in the drawings are marked with the same reference numerals; and a detailed description is omitted as appropriate.

First, an example of an apparatus 100 for FSP and welding configured to perform a welding method of members according to an embodiment will be described. In this example, both FSP and welding are carried out with apparatus 100 by changing tools (FSP tool and welding tool).

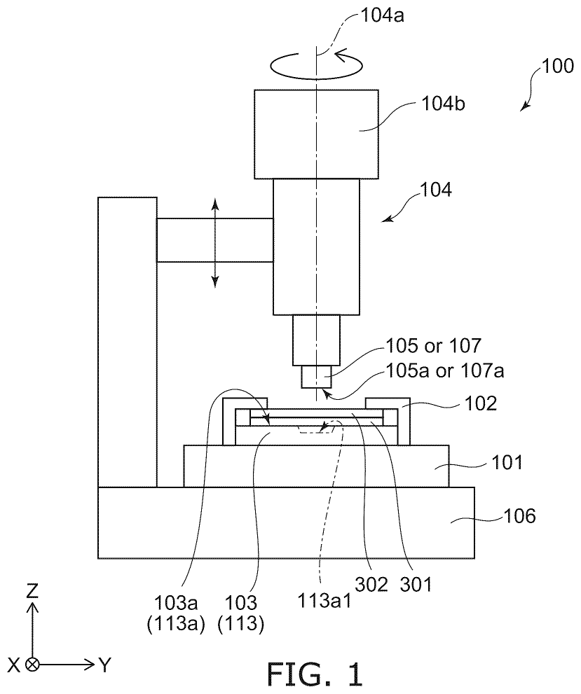

FIG. 1 is a schematic view illustrating the apparatus 100.

Arrows X, Y, Z in FIG. 1 illustrate three mutually orthogonal directions. For example, arrow Z illustrates a vertical direction; and arrows X and Y illustrate horizontal directions.

The apparatus 100 shown in FIG. 1 overlays a member 301 (corresponding to an example of a first member) and a member 302 (corresponding to an example of a second member) and performs spot welding or welding of the members 301 and 302.

As shown in FIG. 1, the apparatus 100 includes, for example, a moving part 101, a holder 102, a backing plate 103 (corresponding to an example of a first backing plate), a processing part 104, a FSP tool 105 or welding tool 107, and a frame 106. The FSP tool 105 is attached in FSP, and the welding tool 107 is attached in welding process.

The moving part 101 can be located at the frame 106. The backing plate 103 and at least one of the members 301 or 302 can be located on the moving part 101. The backing plate 103 and the overlaid members 301 and 302 are disposed in the apparatus 100 illustrated in FIG. 1. The moving part 101 can move in at least one of the X-direction or the Y-direction. The moving part 101 is, for example, a uniaxial table, a biaxial table (an XY table), etc.

For example, the holder 102 can be located at the moving part 101. The holder 102 holds the backing plate 103 and at least one of the members 301 or 302 located on the backing plate 103. The holder 102 is, for example, a chuck, etc.

At least one of the members 301 or 302 is located on the backing plate 103.

A surface 103a of the backing plate 103 at the side opposite to the moving part 101 side can be a flat surface. As described below, there are also cases where a backing plate 113 (corresponding to an example of a second backing plate) is used instead of the backing plate 103. A recess 113a1 is provided in a surface 113a of the backing plate 113 at the member 301 (member 302) side. The recess 113a1 is open at the surface 113a.

The backing plate 103 and the backing plate 113 can be, for example, metal plates. For example, the backing plate 103 and the backing plate 113 are formed from tool steel, carbon steel, etc. However, the materials of the backing plates 103 and 113 are not limited to the examples.

The processing part 104 holds the FSP tool 105 or welding tool 107. The processing part 104 rotates the tools around a central axis 104a. Also, the processing part 104 changes the position of the rotating the tools. For example, the processing part 104 presses an end surface 105a of the FSP tool 105 onto the member 301 or the member 302 by changing the Z-direction position of the rotating FSP tool 105. Similarly, the processing part 104 presses an end surface 107a of the welding tool 107 onto the member 302. The processing part 104 includes, for example, a control motor 104b such as a servo motor, etc.

Both of the FSP tool 105 and the welding tool 107 are, for example, cylindrical. A general FSP tool and welding tool for FSSW includes a stirring pin protruding from the end surface (called the shoulder or the like) of the FSP tool and the welding tool for FSSW. However, the end surface 105a of the FSP tool 105 and the end surface 107a of the welding tool 107 have flat surfaces, and does not include stirring pins. A spiral-shaped groove also can be provided in the end surface 105a of the FSP tool 105 and the end surface 107a of the welding tool 107 respectively. When, however, the spiral-shaped groove can involve risks that the manufacturing cost of the FSP tool 105 or the welding tool 107 may be higher, and the end surface 105a or 107a may be prone to wear, etc. It is more favorable for the end surface 105a and 107a to be a flat surface. The material of the FSP tool 105 and the welding tool 107 can be, for example, tool steel, tungsten alloys, ceramic, etc. The material of the FSP tool 105 and the welding tool 107 are not limited to the examples.

For example, the processing part 104 and the moving part 101 are located at the frame 106. For example, the frame 106 can be mounted to a floor surface of a plant, etc.

The member 301 and the member 302 include metals. In such a case, the material of the member 302 may be the same as or different from the material of the member 301. The materials of the members 301 and 302 can be, for example, aluminum, an aluminum alloy, copper, a copper alloy, titanium, a titanium alloy, magnesium, a magnesium alloy, iron, etc. However, the materials of the members 301 and 302 are not limited to the examples.

Although the configurations of the members 301 and 302 are not particularly limited, the members 301 and 302 can be, for example, plate shaped.

The welding method of members according to the embodiment will now be described.

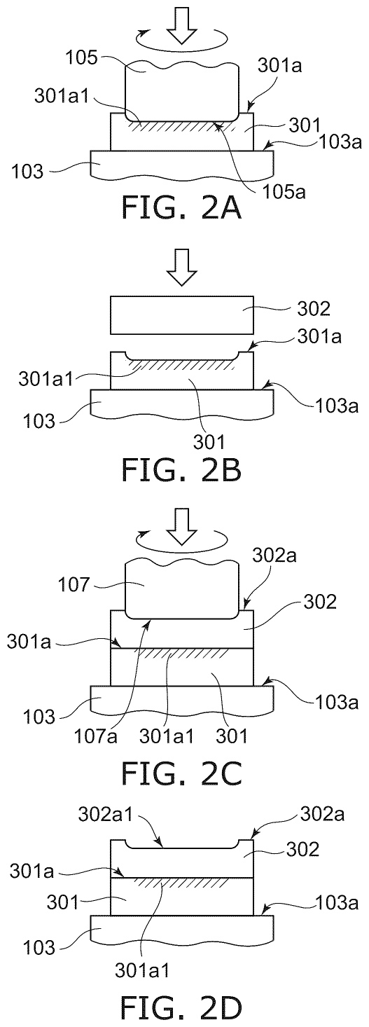

FIGS. 2A to 2D are schematic process drawings illustrating the welding method of members according to the embodiment.

First, as shown in FIG. 2A, a layer 301a1 (corresponding to an example of a first layer) is formed in one surface 301a of the member 301. The layer 301a1 includes a fine grain structure. For example, the fine grain structure includes a crystal grain having a smaller grain size than a crystal grain of the surface 301a of the member 301. For example, when the member 301 is an aluminum alloy (e.g., AA5083), the average grain size of the crystal grains of the surface 301a of the member 301 is, for example, about 30 μm to 100 μm. The average grain size of the crystal grains of the layer 301a1 can be, for example, not more than 5 μm.

As shown in FIG. 2A, the layer 301a1 can be formed by friction stir processing (FSP). For example, by pressing the rotating FSP tool 105 onto the one surface 301a of the member 301 and maintaining for a certain amount of time, a fine grain structure that has high residual strain is formed in the area of the surface 301a of the member 301 onto which the FSP tool 105 is pressed.

When the member 301 is an aluminum alloy (e.g., AA5083), for example, the rotational speed of the FSP tool 105 can be set to about 600 rpm, and the holding time can be set to 3 seconds. For example, the diameter of the end surface 105a of the FSP tool 105 can be about 10 mm. The distance that the end surface 105a of the FSP tool 105 is pressed from the surface 301a of the member 301 (the insertion depth of the FSP tool 105) is, for example, about 0.1 mm.

Here, when the rotational speed of the FSP tool 105 in the FSP is high, the temperature of the area of the member 301 onto which the FSP tool 105 is pressed becomes high. When the temperature of the area is high, the material softens, deformation resistance decreases, and residual strain decreases. As a result, crystal grain refinement becomes to be less to occur. For example, the rotational speed of the FSP tool 105 can be appropriately modified according to the material of the member 301, etc. For example, the relationship between the material of the member 301 and the appropriate rotational speed of the FSP tool 105 can be appropriately determined by performing experiments and/or simulations.

Then, as shown in FIG. 2B, the member 302 to be welded is placed on the surface 301a of the member 301.

Continuing as shown in FIG. 2C, a surface 302a of the member 302 at the side opposite to the member 301 side is pressed and heated. For example, the rotating welding tool 107 is pressed onto the area of the surface 302a of the member 302 overlapping the layer 301a1. In such a case, for example, the rotational speed of the welding tool 107 can be set to 600 rpm. For example, the insertion amount of the welding tool 107 can be set to be 0.45 mm.

By pressing and heating the surface 302a of the member 302 at the side opposite to the member 301 side in a state in which the member 301 and the member 302 are overlaid, the member 301 and the member 302 are welded at the position at which the layer 301a1 is formed as shown in FIG. 2D.

The process and/or mechanism by which the member 301 and the member 302 are welded is not exactly clear, but can be considered to be as follows.

When the layer 301a1 including the fine grain structure having the high residual strain is pressed and heated, the deformation occurs in the interface between the member 301 and the member 302 at first. By this deformation, a part of the surface oxide film is broken. Then, the area in where clean surfaces of the member 301 and the member 302 is closely attached is formed. In parallel, the recrystallization of the fine grain structure progresses due to the temperature rise. The driving force for this recrystallization is bigger than the case of normal-sized crystal grain due to the high strain energy and grain boundary energy. In the process of recrystallization, the grain growth by merging of adjacent crystal grains with each other occurs. When this grain growth occurs in the interface between the member 301 and the member 302 closely attached by the pressure, welding of the member 301 and the member 302 is achieved.

Although FIG. 2D illustrates a case where the layer 301a1 including the fine grain structure remains after the welding between the member 301 and the member 302, there are also cases where the recrystallization causes the layer 301a1 including the fine grain structure to disappear or substantially disappear.

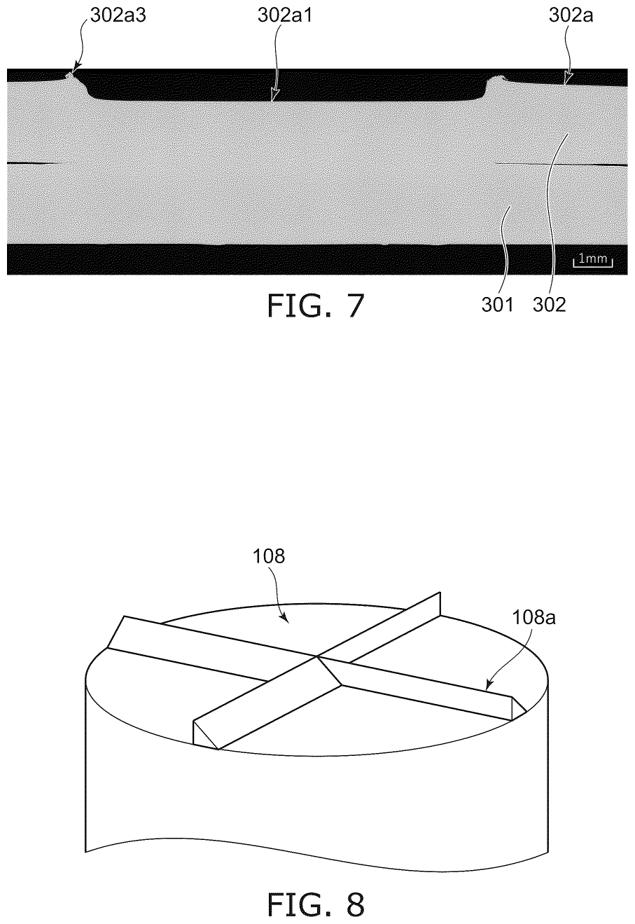

According to the welding method of members according to the embodiment as shown in FIG. 2C, the end surface 107a of the welding tool 107 is a flat surface without a stirring pin. Therefore, as shown in FIG. 2D, even if a shallow recess 302a1 having a depth of about 0.45 mm remains in the surface 302a of the member 302, a deep recess having the transferred shape of the stirring pin is not formed (see FIGS. 6 and 7).

In other words, according to the welding method of members according to the embodiment, the occurrence of a deep recess in the welding portion can be suppressed even when using the welding tool 107 having a simple configuration.

By suppressing the occurrence of a deep recess in the welding portion, the welding portion can be prevented from detracting from the aesthetics of the product. In a shallow recess, compared to a deep recess, moisture and the like does not collect easily, the contact area between the moisture and the outside air is greater, and the time necessary to evaporate is less; therefore, degradation of the reliability of the welding portion and/or product can be suppressed.

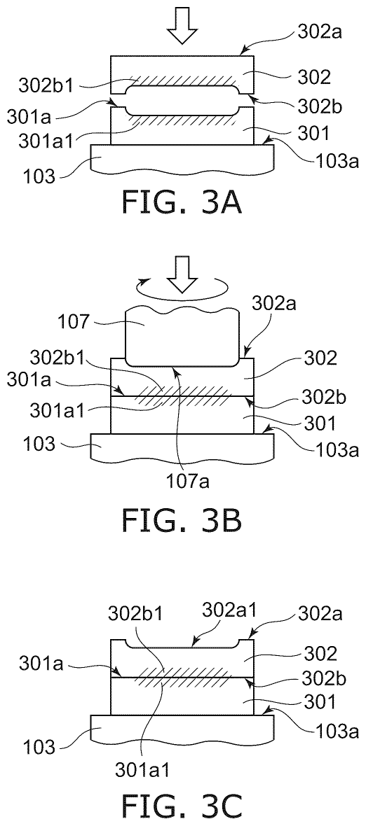

FIGS. 3A to 3C are schematic process drawings illustrating a welding method of members according to another embodiment.

First, the layer 301a1 is formed in the one surface 301a of the member 301 similarly to FIG. 2A above.

Similarly to FIG. 2A, a layer 302b1 (corresponding to an example of a second layer) is formed in one surface 302b of the member 302. The layer 302b1 includes a fine crystal grain structure. For example, the fine crystal grain structure includes a crystal grain having a smaller size than a crystal grain of the surface 302b of the member 302. For example, when the member 302 is an aluminum alloy (e.g., AA5083), the average grain size of the crystal grains of the surface 302b of the member 302 is, for example, about 30 μm to 100 μm. The average grain size of the crystal grains of the layer 302b1 can be, for example, not more than 5 μm.

For example, the formation method and formation conditions of the layer 302b1 can be similar to the formation method and formation conditions of the layer 301a1 described above.

Then, as shown in FIG. 3A, the member 302 to be welded is placed on the surface 301a of the member 301. At this time, the surface 302b of the member 302 at the side at which the layer 302b1 is formed is caused to face the surface 301a side of the member 301. When the member 302 is viewed along the overlaying direction with the member 301, at least a portion of the layer 302b1 formed in the member 302 is caused to overlap the layer 301a1 formed in the member 301.

Continuing as shown in FIG. 3B, the surface 302a of the member 302 at the side opposite to the member 301 side is pressed and heated. For example, the rotating welding tool 107 is pressed onto an area of the surface 302a of the member 302 overlapping the layers 301a1 and 302b1. In such a case, for example, the rotational speed of the welding tool 107 can be set to 600 rpm. The insertion depth of the welding tool 107 can be set to be, for example, 0.45 mm.

By pressing and heating the surface 302a of the member 302 at the side opposite to the member 301 side in the state in which the member 301 and the member 302 are overlaid, the member 301 and the member 302 are welded at a position at which at least one of the layers 301a1 or the layer 302b1 is formed as shown in FIG. 3C. The process and/or mechanism of the welding of the layer 302b1 can be considered to be similar to those described above.

In such a case, higher strength welding is possible because intense recrystallization progresses in each of the layers 301a1 and 302b1 in an area at which the layers 301a1 and 302b1 overlap. In this case, the FSP tool 105 of larger diameter than that of the welding tool is used to prevent the decreasing of the weld strength due to misalignment of the layers 301a1 and 302b1. Although FIG. 3C illustrates a case where the layers 301a1 and 302b1 including fine crystal grain structures remain after the welding between the member 301 and the member 302, there are also cases where recrystallization causes the layers 301a1 and 302b1 including the fine grain structures to disappear or substantially disappear.

According to the welding method of members according to the embodiment as well, as shown in FIG. 3B, the end surface 107a of the welding tool 107 is a flat surface without a stirring pin. Therefore, even if the shallow recess 302a1 remains in the surface 302a of the member 302 as shown in FIG. 3C, a deep recess that has the transferred shape of a stirring pin is not formed (see FIGS. 6 and 7).

In other words, according to the welding method of members according to the embodiment, the occurrence of a deep recess in the welding portion can be suppressed even when using the welding tool 107 having a simple configuration.

By suppressing the occurrence of a deep recess in the welding portion, the welding portion can be prevented from detracting from the aesthetics of the product. In a shallow recess, compared to a deep recess, moisture and the like does not collect easily, the contact area between the moisture and the outside air is greater, and the time necessary to evaporate is less; therefore, degradation of the reliability of the welding portion and/or product can be suppressed.

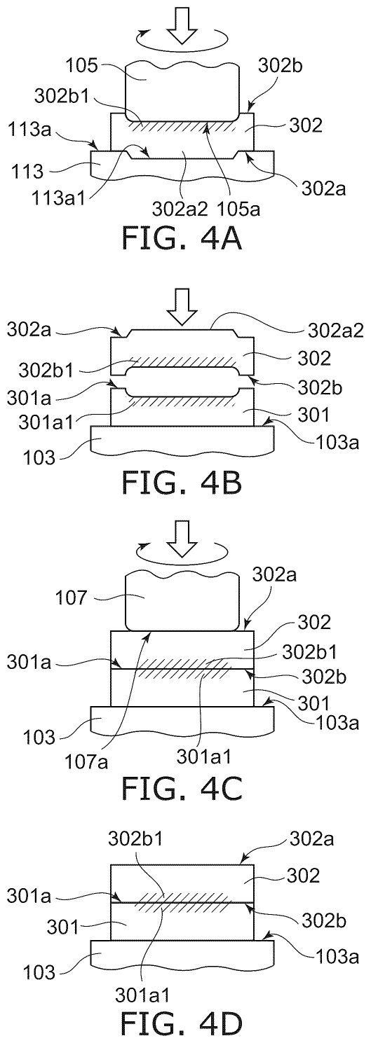

FIGS. 4A to 4D are schematic process drawings illustrating a welding method of welding members according to another embodiment.

First, similarly to FIG. 2A above, the layer 301a1 is formed in the one surface 301a of the member 301.

As shown in FIG. 4A, the layer 302b1 is formed in the one surface 302b of the member 302.

As shown in FIG. 4A, the layer 302b1 can be formed by FSP. For example, by pressing the rotating FSP tool 105 onto the one surface 302b of the member 302, a fine crystal grain structure that has a high residual strain is formed in the area of the surface 302b of the member 302 onto which the FSP tool 105 is pressed. For example, the formation conditions of the layer 302b1 can be set such that the rotational speed of the FSP tool 105 is 600 rpm, and the insertion depth of the FSP tool 105 is 0.3 mm.

However, according to the welding method of members illustrated in FIGS. 2A to 3C, the surface 103a of the backing plate 103 on which the member 301 (the member 302) is placed is a flat surface. In contrast, as shown in FIG. 4A, the recess 113a1 is provided in the surface 113a of the backing plate 113 on which the member 302 is placed. The opening dimension of the recess 113a1 can be equal to or slightly greater than the diameter of the end surface 105a of the FSP tool 105. The depth of the recess 113a1 can be about equal to the insertion depth of the FSP tool 105.

As shown in FIG. 4A, if the recess 113a1 is provided in the surface 113a of the backing plate 103 on which the member 302 is placed, the surface 302a side of the member 302 is pressed into the recess 113a1 to form a protrusion 302a2 when the FSP tool 105 is inserted into the member 302.

In other words, the layer 302b1 is formed in the surface 302b of the member 302; and the protrusion 302a2 is formed in the surface 302a overlapping the surface 302b. The protrusion 302a2 is formed at a position overlapping the layer 302b1.

For example, the formation conditions of the layer 302b1 can be set such that the rotational speed of the FSP tool 105 is similar to the formation conditions of the layer 301a1 described above, and the insertion depth of the FSP tool 105 is set to be, for example, 0.3 mm.

Then, as shown in FIG. 4B, the member 301 is placed on the backing plate 103 including the flat surface 103a. The member 302 to be welded is placed on the surface 301a of the member 301.

At this time, the surface 302b of the member 302 at the layer 302b1 side is caused to face the surface 301a side of the member 301. When the member 302 is viewed along the overlaying direction of the member 301, at least a portion of the layer 302b1 formed in the member 302 is caused to overlap the layer 301a1 formed in the member 301.

By placing the member 302 in this manner, the protrusion 302a2 provided in the surface 302a of the member 302 overlaps the layer 301a1 formed in the member 301.

Then, as shown in FIG. 4C, the protrusion 302a2 that is provided in the surface 302a of the member 302 is pressed and heated. For example, the rotating welding tool 107 is pressed onto the top surface of the protrusion 302a2. In such a case, for example, the rotational speed of the welding tool 107 can be 600 rpm. The insertion depth of the welding tool 107 can be set to be 0.4 mm from the surface of the protrusion 302a2 of the member 302.

As described above, the insertion depth of the welding tool 107 can be set to be about equal to the summed value of the depth of the recess 113a1 of the backing plate 113 and the depth of the recess 301a1 of the member 301. In other words, the insertion depth of the welding tool 107 can be set to be about equal to the summed value of the height of the protrusion 302a2 and the depth of the recess 301a1 of the member 301.

If the insertion depth of the welding tool 107 is about equal to the summed value of the height of the protrusion 302a2 and the depth of the recess 301a1, the distance between the top surface of the protrusion 302a2 and the surface 302a of the member 302 in the thickness direction of the member 302 when the rotating FSP tool 105 is pressed onto the protrusion 302a2 can be about 0.1 mm, which is about the depth of the recess 301a1 of the member 301 before welding, as shown in FIG. 4D.

In other words, according to the method for welding members according to the embodiment, the occurrence of a deep recess in the welding portion can be suppressed even when using the FSP tool 105 having a simple configuration. The depth of the recess 302a1 described above can be even shallower.

Therefore, the welding portion can be further prevented from detracting from the aesthetics of the product. Even when the recess 302a1 occurs, the depth of the recess 302a1 can be shallower, and so the moisture and the like collect less easily. Therefore, degradation of the reliability of the welding portion and/or product can be further suppressed.

Although a case is illustrated above where the layer 301a1 is formed in the one surface 301a of the member 301, it is also possible to weld the member 301 in which the layer 301a1 is not formed, similarly to the member 302 of FIG. 2B above.

Although a case is described where the layer 302b1 and the protrusion 302a2 are formed in the member 302, the layer 301a1 and a protrusion also can be formed in the member 301. The formation method and formation conditions when forming the protrusion in the member 301 can be, for example, the same as the formation method and formation conditions when forming the protrusion 302a2 in the member 302.

Here, as described above, there are cases where the material of the member 301 and the material of the member 302 are different. When the materials are different, there are cases where the difference between the melting point of the material of the member 301 and the melting point of the material of the member 302 is large. When the material melting point difference is large, and when recrystallizing the fine grain structures by pressing and heating the member 301 and the member 302, there are cases where the welding is difficult because the material having a lower melting point could melts.

In general, recrystallization of the fine crystal grain structure occurs at a temperature of about half of the melting point of the base material. Therefore, this welding method can be used in the case in which the melting point of one of the materials of the member 301 or the material of the member 302 to be a temperature that is not less than half of the melting point of the other material. Under the aforementioned condition, good welding can be performed even when the material of the member 301 and the material of the member 302 are different. For example, the appropriate welding temperature when the material of the member 301 and the material of the member 302 are different can be appropriately determined by performing experiments and/or simulations. For example, the temperature can be adjusted by the rotational speed, pressing time, insertion depth of the welding tool 107, etc.

Although a case is illustrated above where the member 301 and the member 302 are welded by using the rotating welding tool 107 to press and heat the member 301 and the member 302, the method of pressing and heating is not limited thereto.

For example, the member 301 and the member 302 can be pressed and heated using a tool with a heater, etc. Thus, recrystallization is possible for the layer 301a1 or the layer 302b1 including the fine grain structure having large residual strain.

Also, the member 301 and the member 302 can be pressed and heated using a tool connected to an ultrasonic transducer. In such a case, the layer 301a1 or the layer 302b1 including the fine crystal grain structure having high residual strain is heated by frictional heat generated by ultrasonic vibrations between the tool and the member 302. Therefore, in this manner as well, recrystallization is possible for the layer 301a1 or the layer 302b1 including the fine crystal grain structure having high residual strain.

If, however, the member 301 and the member 302 are pressed and heated using the rotating welding tool 107, the formation of the layer 301a1 or the layer 302b1 including the fine crystal grain structure having high residual strain and the pressing and heating of the members 301 and 302 can be performed using the same apparatus 100. In other words, the welding apparatus 100 and/or manufacturing processes can be shared, and so the manufacturing cost can be reduced, and the manufacturing lead time can be shortened.

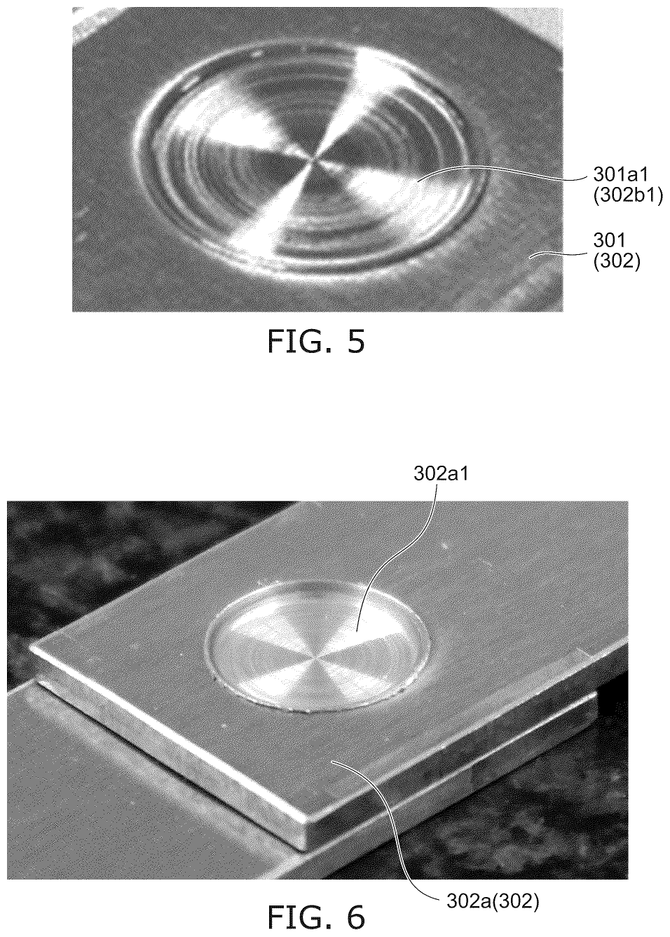

FIG. 5 is a photograph of the surface of the member after FSP.

The material is an aluminum alloy (AA5083). The rotational speed of the FSP tool 105 is 600 rpm. The diameter of the end surface 105a of the FSP tool 105 is 10 mm. The insertion depth of the FSP tool 105 is 0.1 mm.

As can be seen in FIG. 5, by forming the layer 301a1 or the layer 302b1 by FSP, a shallow recess is formed in the area in which the layer 301a1 or the layer 302b1 is formed. The layer 301a1 or the layer 302b1 including the fine crystal grain structure having high residual strain is formed in the surface of the recess. FIG. 6 is a photograph of the members 301 and 302 after welding by frictional heat and pressing using the rotating welding tool 107.

The materials of the members 301 and 302 are an aluminum alloy (AA5083). The rotational speed of the welding tool 107 is 600 rpm. The diameter of the end surface 107a of the welding tool 107 is 10 mm. The insertion depth of the welding tool 107 is 0.45 mm.

As can be seen in FIG. 6, the flat shallow recess 302a1 is formed in the surface 302a of the member 302.

FIG. 7 is a photograph of a cross section of a welded portion of the members 301 and 302 showed in FIG. 6.

The thicknesses of the members 301 and 302 are 2 mm.

As can be seen in FIG. 7, the shallow recess 302a1 is formed in the surface 302a of the member 302. However, the bottom surface of the recess 302a1 is flat, and a deep recess having the transferred shape of the stirring pin is not formed.

As can be seen in FIG. 7, there are cases where burr 302a3 occurs at the perimeter edge of the recess 302a1. Such burr 302a3 can be removed as necessary. For example, in the apparatus 100 illustrated in FIG. 1, the burr 302a3 can be easily removed by using a cutting tool such as an end mill or the like instead of the FSP tool 105 or the welding tool 107. In other words, the FSP and the welding, the deburring can be carried out by the same apparatus 100.

As described above, the welding method of members according to the embodiment can include the following processes:

A process of forming the layer 301a1 including the fine crystal grain structure in the surface 301a of the member 301 at the side opposite to the backing plate 103 side by using the rotating FSP tool 105 to perform FSP.

A process of placing the member 302 on the surface 301a of the member 301 at the layer 301a1 side.

A process of pressing and heating an area of the surface 302a of the member 302 overlapping the layer 301a1 at the side opposite to the member 301 side.

Furthermore, a process of forming the layer 302b1 including the fine crystal grain structure in the surface 302b of the member 302 at the side opposite to the backing plate 103 side by using the rotating FSP tool 105 to perform the FSP can be included.

In such a case, the process of placing the member 302 described above can include placing the layer 302b1 side of the member 302 at the layer 301a1 side of the member 301.

The process of forming the layer 302b1 including the fine crystal grain structure can include using the backing plate 113 including the recess 113a1 open at the member 302 side instead of the backing plate 103, forming the layer 302b1 in the surface 302b of the member 302 at the side opposite to the backing plate 113 side, and forming the protrusion 302a2 in a portion of the member 302 facing the recess 113a1 of the backing plate 113 side.

The process of pressing and heating the area of the surface 302a of the member 302 overlapping the layer 301a1 at the side opposite to the member 301 side can include pressing and heating the protrusion 302a2 of the member 302.

The process of pressing and heating the area of the surface 302a of the member 302 overlapping the layer 301a1 at the side opposite to the member 301 side can include pressing the rotating welding tool 107 onto the area of the member 302 overlapping the layer 301a1.

Although case is illustrated above where the rotating FSP tool 105 is pressed onto the member 301 or the member 302, the FSP tool 105 can be pressed onto the member 301 or the member 302 and moved in a direction crossing a central axis of the FSP tool 105. Thus, the layer 301a1 or the layer 302b1 that has a band shape extending in the movement direction of the FSP tool 105 can be formed.

When pressing and heating the member 301 and the member 302 as well, recrystallization of the layer 301a1 or the layer 302b1 that has a band shape is possible by moving the welding tool 107 in a direction crossing the central axis of the welding tool 107. Therefore, a band-shaped welding portion can be formed between the member 301 and the member 302.

In such a case, a FSP tool that includes a stirring pin having a lower height than the thicknesses of the members 301 and 302 may be used.

As described above, when forming a spot-like area including a layer of a fine crystal grain structure, it is favorable for the end surface 105a of the FSP tool 105 to be a flat surface, and for the FSP tool 105 to be without a stirring pin.

On the other hand, when forming a layer including a band-shaped fine grain structure, a FSP tool that includes a columnar stirring pin protruding from the end surface 105a of the FSP tool 105 also can be used. In such a case, it is sufficient for the length in the height direction (the protruding direction) of the stirring pin to be less than the thickness-direction length of the thinner member among the members 301 and 302. In other words, it is sufficient for the FSP tool to include a stirring pin at the tip of the FSP tool, and for the height-direction length of the stirring pin to be less than the thickness-direction length of the member 301 or 302 subjected to FSP.

The height-direction length of the stirring pin is the dimension between the end surface of the FSP tool and the tip (the protruding end) of the stirring pin in a direction along the central axis of the FSP tool.

As examples of FSP tools, a FSP tool having a flat surface and a FSP tool having a low height stirring pin are described above. Additionally, it also can be used a FSP tool 108 which has uniform height protrusions of blade-like shape shown in FIG. 8 to form a spot-like or band-like area including a layer of a fine crystal grain structure.

The process of pressing and heating the area of the surface 302a of the member 302 overlapping the layer 301a1 at the side opposite to the member 301 side can include moving the rotating welding tool 107 along the fine crystal grain structure layer formed in the band shape in a direction crossing the central axis of the welding tool 107. In such a case, a welding tool that includes a stirring pin having a lower height than the thicknesses of the members 301 and 302 may be used.

Other than the method of pressing with the rotating welding tool 107, the process of welding the member 301 and the member 302 may be a method of welding using generated frictional heat by applying an ultrasonic vibration to the welding tool 107 while pressing the overlapped members 301 and 302 by the welding tool 107.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments herein may be made without departing from the spirit of the inventions. The accompanying claims and their equivalents are intended to cover such forms or modifications as would fall within the scope and spirit of the inventions. Moreover, above-mentioned 10 embodiments can be combined mutually and can be carried out.

What is claimed is:

1. A welding method of members, the method comprising:
forming a first layer in a first member on a first backing plate by rotating a friction stir processing tool to perform friction stir processing, the first layer including a fine crystal grain structure, the first layer being formed in a surface of the first member at a side opposite to the first backing plate side;
placing a second member on a surface of the first member at the first layer side; and
pressing and heating an area of a surface of the second member at a side opposite to the first member side, the area overlapping the first layer.

2. The welding method according to claim 1, wherein
when performing the friction stir processing, the rotating friction stir processing tool is pressed onto the surface of the first member, and the rotating friction stir processing tool is moved in a direction crossing a central axis of the friction stir processing tool.

3. The welding method according to claim 1, wherein
at least a portion of an end surface of the friction stir processing tool at the first member side is a flat surface including a rotation center of the end surface.

4. The welding method according to claim 1, wherein
the friction stir processing tool includes a stirring pin at a tip of the friction stir processing tool, and
a length in a height direction of the stirring pin is less than a length in a thickness direction of the first member.

5. The welding method according to claim 1, further comprising:
forming a second layer in a second member on the first backing plate by using the rotating friction stir processing tool to perform friction stir processing, the second layer including a fine crystal grain structure, the second layer being formed in a surface of the second member at a side opposite to the first backing plate side; and
placing the second layer side of the second member on the first layer side of the first member in the placing of the second member.

6. The welding method according to claim 5, wherein
the forming of the second layer including the crystal fine grain structure includes:
using a second backing plate instead of the first backing plate, the second backing plate including a recess open at a surface of the second backing plate at the second member side;
forming the second layer in a surface of the second member at a side opposite to the second backing plate side; and
forming a protrusion in a portion of the second member facing the recess at the second backing plate side of the second member, and
the pressing and heating of the area of the surface of the second member overlapping the first layer at the side opposite to the first member side includes pressing and heating the protrusion of the second member.

7. The welding method according to claim 1, wherein
the pressing and heating of the area of the surface of the second member overlapping the first layer at the side opposite to the first member side includes pressing the rotating welding tool onto the area of the surface of the second member overlapping the first layer.

8. The welding method according to claim 7, wherein
at least a portion of an end surface of the welding tool at the second member side is a flat surface including a rotation center of the end surface.

9. The welding method according to claim 3, wherein the friction stir processing tool and the friction stir processing tool is same or have same dimensions.

10. The welding method according to claim 7, wherein
the pressing and heating of the area of the surface of the second member at the side opposite to the first member side overlapping the first layer includes moving the rotating welding tool in a direction crossing a central axis of the welding tool.

11. The welding method according to claim 7, wherein
the welding tool includes a stirring pin at a tip of the welding tool, and
a length in a height direction of the stirring pin is less than a length in a thickness direction of the second member subjected to the friction stir processing.

12. The welding method according to claim 1, wherein
the first layer includes a crystal grain having a smaller grain size than a crystal grain of the surface of the first member.

13. The welding method according to claim 1, wherein
the first member and the second member are welded by the pressing and the heating of the area of the second member overlapping to the first layer of the first member.

14. The welding method according to claim 12, wherein
at least a part of the first layer remains after the welding between the first member and the second member.

15. The welding method according to claim 12, wherein
the first layer disappears after the welding between the first member and the second member.

16. The welding method according to claim 5, wherein
the second layer includes a crystal grain having a smaller grain size than a crystal grain of another part of the second member.

17. The welding method according to claim 5, wherein
the first member and the second member are welded at a position of at least one of the first layer or the second layer is formed, by pressing and heating at the area of the second member overlapping to the first layer of the first member.

18. The welding method according to claim 17, wherein
at least a part of the first layer, the second layer, or both the first and second layers remains after the welding of the first member and the second member.

19. The welding method according to claim 17, wherein
the first layer and the second layer almost disappear after the welding of the first member and the second member.

20. The welding method according to claim 1, wherein
a melting point (degree celsius) of the first member is not less than half of a melting point (degree celsius) of the material of the second member.
